(19) United States
(12) Patent Application Publication
(10) Pub. No.: US 2024/0037766 A1
(43) Pub. Date: Feb. 1, 2024

(54) SYSTEMS AND METHODS FOR GEOREGISTRATION SERVICE

(71) Applicant: Palantir Technologies Inc., Denver, CO (US)

(72) Inventors: Joseph Driscoll, San Francisco, CA (US); Aleksandr Patsekin, Foster City, CA (US); Ethan Van Andel, Berkeley, CA (US); Mary Cameron, Washington, DC (US); Miles Sackler, Seattle, WA (US); Robert Imig, Washington, DC (US); Stephen Ramsey, Mountain View, CA (US)

(73) Assignee: Palantir Technologies Inc., Denver, CO (US)

(21) Appl. No.: 18/226,601

(22) Filed: Jul. 26, 2023

Related U.S. Application Data
(60) Provisional application No. 63/393,484, filed on Jul. 29, 2022.
(60) Provisional application No. 63/424,633, filed on Nov. 11, 2022.

(51) Int. Cl. G06T 7/33; G06F 16/532; G06T 7/73; G06T 7/37

(52) U.S. Cl. CPC G06T 7/337; G06F 16/532; G06T 7/74; G06T 7/37; G06T 2207/10032

(57) ABSTRACT

Systems and methods for video georegistration are provided. An example method includes: receiving an input image; generating a plurality of templates from the input image; and generating a template queue based at least in part on the plurality of template scores. The plurality of templates are associated with a plurality of template scores. The template queue includes a set of selected templates. The method further includes receiving one or more reference images; determining a set of match scores for the set of selected templates by applying a matching algorithm to the set of selected templates and at least one reference image of the one or more reference images; evaluating the set of match scores to select a collection of templates, and generating an image transform based at least in part on the collection of templates. Each template of the collection of templates meets one or more selection criteria.

### CROSS REFERENCE TO RELATED APPLICATIONS

This application claims priority to U.S. Provisional Application Nos. 63/393,484 and 63/424,633, both entitled “SYSTEMS AND METHODS FOR GEOREGISTRATION SERVICE,” filed on Jul. 29, 2022 and Nov. 11, 2022, respectively, which are incorporated by reference herein for all purposes in their entirety.

### TECHNICAL FIELD

Certain embodiments of the present disclosure relate to georegistration services. More particularly, some embodiments of the present disclosure relate to aligning received images, such as satellite images, with a coordinate location.

### BACKGROUND

Georegistration is a process for aligning two or more images or datasets spatially to a common coordinate system. In some examples, georegistration involves finding a transformation that maps points in one image or dataset to corresponding points in another image or dataset. In certain examples, georegistration services for images and/or videos face numerous challenges, including visual variations between images and/or videos, minimal structured content in the images and/or videos, noise, rotation changes, scale changes, and/or perspective changes between images and/or videos.

Hence, it is desirable to improve techniques for performing georegistration for images and/or videos.

### SUMMARY

Certain embodiments of the present disclosure relate to georegistration. More particularly, some embodiments of the present disclosure relate to performing reference georegistration using one or more reference images.

At least some aspects of the present disclosure are directed to a method for image georegistration, the method includes: receiving an input image; and generating a plurality of templates from the input image. The plurality of templates are associated with a plurality of template scores. The method further includes generating a template queue based at least in part on the plurality of template scores. The template queue includes a set of selected templates. The method further includes receiving one or more reference images; determining a set of match scores for the set of selected templates by applying a matching algorithm to the set of selected templates and at least one reference image of the one or more reference images; and evaluating the set of match scores to select a collection of templates. Each template of the collection of templates meets one or more selection criteria. The method further includes generating an image transform based at least in part on the collection of templates. The method is performed using one or more processors.

At least some aspects of the present disclosure are directed to a system for image georegistration. The system includes: one or more memories having instructions stored thereon; and one or more processors configured to execute the instructions and perform operations including: receiving an input image; and generating a plurality of templates from the input image. The plurality of templates are associated with a plurality of template scores. The operations further include generating a template queue based at least in part on the plurality of template scores. The template queue includes a set of selected templates. The operations further include receiving one or more reference images; determining a set of match scores for the set of selected templates by applying a matching algorithm to the set of selected templates and at least one reference image of the one or more reference images; and evaluating the set of match scores to select a collection of templates. Each template of the collection of templates meets one or more selection criteria. The operations further include generating an image transform based at least in part on the collection of templates.

At least some aspects of the present disclosure are directed to a method for image georegistration, the method includes: receiving an input image; and generating a plurality of templates from the input image. The plurality of templates are associated with a plurality of template scores, and each template of the plurality of templates is associated with a pixel location in the input image. The method further includes generating a template queue based at least in part on the plurality of template scores and a plurality of pixel locations associated with the plurality of templates. The template queue includes a set of selected templates, and the template queue is based at least in part on the plurality of template scores. The method further includes receiving one or more reference images; determining a set of match scores for the set of selected templates by applying a matching algorithm to the set of selected templates and at least one reference image of the one or more reference images; and evaluating the set of match scores to select a collection of templates. Each template of the collection of templates meets one or more selection criteria. The method further includes generating an image transform based at least in part on the collection of templates. The method is performed using one or more processors.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 illustrates a simplified diagram showing a software architecture for a georegistration system, according to certain embodiments of the present disclosure.

FIG. 2 illustrates a simplified diagram showing a method for georegistration, according to certain embodiments of the present disclosure.

FIG. 3 illustrates a simplified diagram showing a method for sorting templates and/or generating a template queue according to certain embodiments of the present disclosure.

FIG. 4 illustrates a simplified diagram showing a method for generating a transformation according to certain embodiments of the present disclosure.

FIG. 5 illustrates an example image divided into a plurality of cells according to certain embodiments of the present disclosure.

FIG. 6 illustrates an example of transform between a template and a reference image according to certain embodiments of the present disclosure.

FIG. 7 is an illustrative example of a georegistration environment, according to certain embodiments of the present disclosure.

FIG. 8A illustrates a registered image in comparison to a data source with an alignment that is off by a large distance, according to certain embodiments of the present disclosure.

FIG. 8B illustrates the registered image and data source of FIG. 8 with a better alignment, after a georegistration process according to certain embodiments of the present disclosure.

FIG. 9A illustrates an example input image according to certain embodiments of the present disclosure.

FIG. 9B illustrates an example reference image according to certain embodiments of the present disclosure.

FIG. 9C illustrates an example registered image generated based on the example input image of FIG. 9A and reference image of FIG. 9B according to certain embodiments of the present disclosure.

FIG. 10 is an illustrative diagram of a video georegistration according to certain embodiments of the present disclosure.

FIG. 11 illustrates a simplified diagram showing a computing system for implementing a system for georegistration, according to certain embodiments of the present disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods are often not capable of effectively addressing visual variations of images/videos, such as lighting changes, temporal changes (e.g., seasonal changes), sensor mode (e.g., electro-optical (EO), infrared (IR), synthetic-aperture radar (SAR), etc.). Additionally and/or alternatively, conventional systems and methods typically cannot perform georegistration on images/videos with minimal structured content (e.g., forest, fields, water, etc.). Further, images/videos may have noise and/or changes in rotation, scale, and/or perspective which conventional systems and methods typically are unable to address.

Various embodiments of the present disclosure can achieve benefits and/or improvements by a computing system implementing one or more reference georegistrations using one or more corresponding reference images. For example, mechanisms provided herein may generate templates from an input image and apply a matching algorithm to a subset of the templates based on one or more reference images. In certain embodiments, a template is a portion of an image. In some embodiments, the subset of the templates may be scored based on the matching algorithm and the scores may be evaluated to select a collection of templates used to generate an image transform. In some embodiments, the image transform may be applied to the input image to generate a registered image. In some embodiments, benefits include the ability to perform georegistration on input images that conventional systems or methods were previously unable to effectively perform georegistration thereon. In some embodiments, benefits include calibration processes with lightweight computational costs to enable improved georegistration. Generally, georegistration performed according to mechanisms provided herein is more accurate than conventional mechanisms, such as by using and/or in consequence of the use of high-quality control points (e.g., template points, candidate points, etc.), appropriate transformation models, effective calibration to minimize error, and/or other processes that may be understood by those of ordinary skill in the art, at least in light of teaching provided herein.

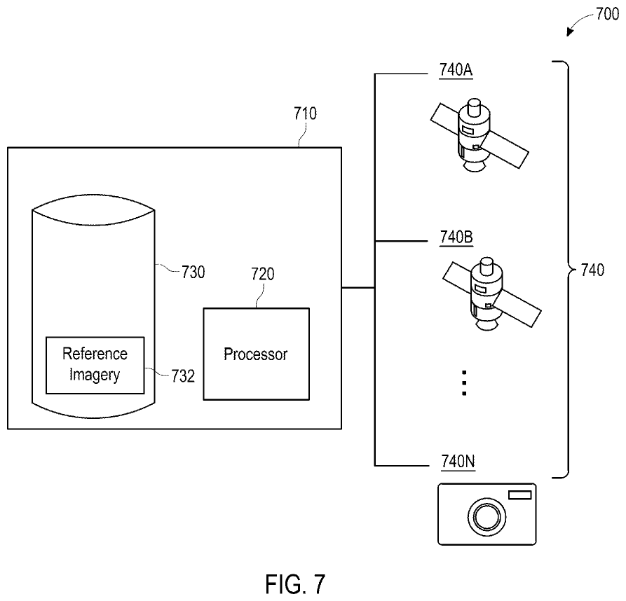

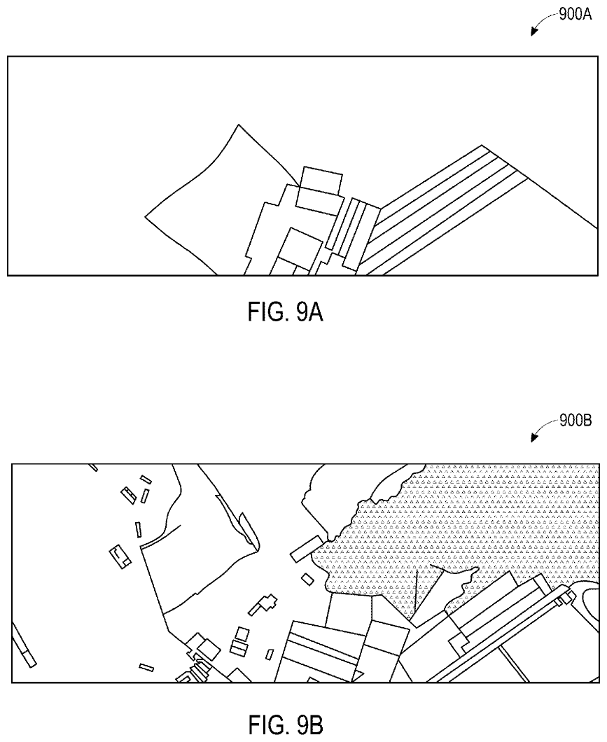

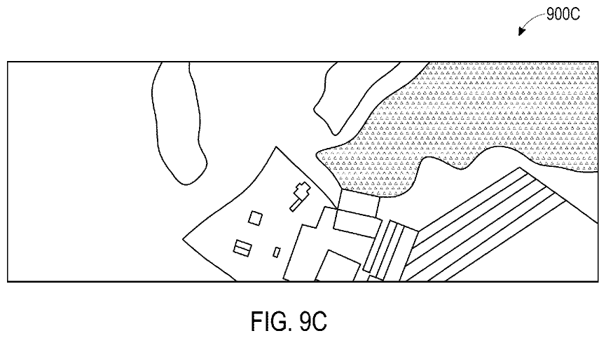

As an example, in some embodiments, input images may be received from one or more satellites (e.g., input image 900A of FIG. 9A may be received from satellites or imaging systems 740 of FIG. 7 discussed later herein). In some embodiments, the images are received at a georegistration system 710 that includes one or more stored reference images (e.g., reference image 900B of FIG. 9B). The reference image (e.g., an image of a coast, city, or other geographic location) may be associated with geographic coordinates and/or the input image (e.g., also an image of the coast, city, or other geographic location) may be associated with geographic coordinates.

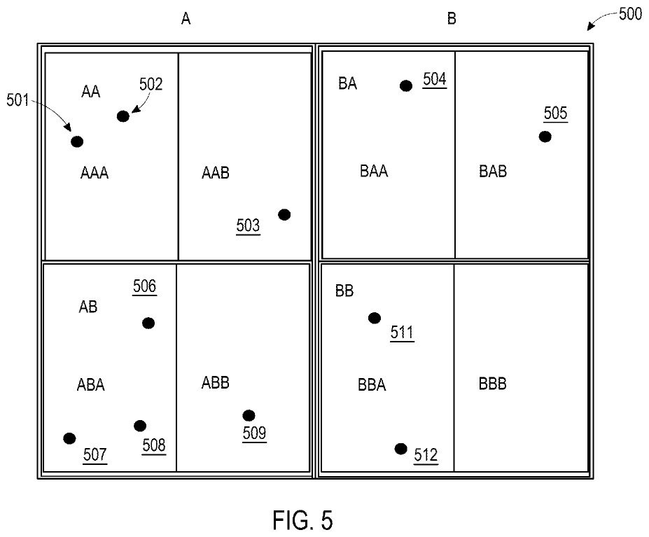

In some embodiments, a plurality of templates may be generated from the input image, for example, such that candidate points (e.g., points 501-512 of FIG. 5) of the plurality of templates correspond to pixel locations of the input image. Each candidate point (e.g., selected using Harris Corner detection algorithm or another key feature detection algorithm) may have a likelihood of match success for matching with a corresponding location on the reference image. For example, a top of a building shown in the input image may be a candidate point that matches to the top of the same building shown in the reference image. Accordingly, the georegistration system may compute a transform, such as using the Levenberg-Marquardt nonlinear algorithm, or another error reduction algorithm, to reduce error between corresponding pixels/vectors of the reference and input images. In some embodiments, the transform matches the largest number of candidate points from the reference image to points on the input image. In some embodiments, the computed transform may allow for points between the reference and input images to be lined-up to generate a registered image (e.g., registered image 900C of FIG. 9C, which was generated based on points matched between input image 900B and reference image 900A).

Therefore, according to some embodiments of the present disclosure, satellite images may be lined up with reference images to generate registered images that are of higher quality than conventional georegistration systems, and that allow for accurate visual processing of aerial/geographic imagery. The registered images may be viewable by a user, such as on one or more displays of a computing device, or used for subsequent processing. Additional and/or alternative examples of mechanisms provided herein will be recognized by those of ordinary skill in the art, in light of the present disclosure.

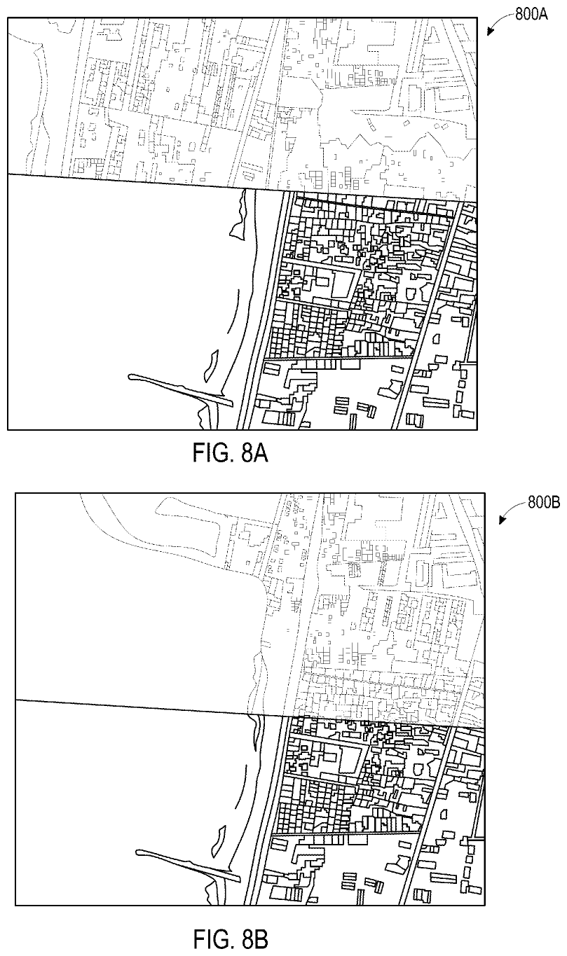

At least some embodiments of the present disclosure are directed to systems and methods for georegistration for images, including georegistration for satellite images. In certain embodiments, the georegistration system (e.g., a georegistration service) is configured to receive (e.g., obtain) an image off of a satellite platform and align the received image with a location or a map so the system can determine the coordinates of an image portion. In some embodiments, after the georegistration process is completed, a software system can compare the georegistered image, also referred to as a registered image, with one or more other data sources (e.g., one or more other images). In some examples, when an image is obtained from a satellite, it will have basic coordinates computed. In certain examples, the alignment may be off by a large distance (e.g., 600 meters, tens to thousands of meters), as shown in an example illustrated in FIG. 8A. FIG. 8B is an example image showing a better alignment after the georegistration process.

In some examples, georegistration, also known as image registration or geometric registration, is a process for aligning two or more images or datasets spatially to a common coordinate system. In certain examples, georegistration involves finding a transformation that maps points in one image or dataset to corresponding points in another image or dataset. Accordingly, in some examples, a goal of georegistration is to accurately overlay and align images or datasets so that they can be compared, analyzed, or combined effectively.

In certain embodiments, georectification refers to assigning geo-coordinates to an image. In some embodiments, orthorectification refers to warping an image to match the top-down view. In certain examples, orthorectification includes reshaping hillsides and such so it looks like the image was taken directly from overhead rather than at a side angle. In some embodiments, georegistration refers to refining the geo-coordinates of an image based on reference imagery. In certain embodiments, image registration refers to, given an input image and one or more reference images, find a transform mapping the input image to the corresponding part of the one or more reference images. In some embodiments, image registration has one or more challenges: 1) images have visual variations, for example, lighting changes, temporal changes (e.g., seasonal changes), sensor mode (e.g., electro-optical (EO), infrared (IR), synthetic-aperture radar (SAR), etc.); 2) images have minimal structured content (e.g., forest, fields, water, etc.); 3) images have image noise (e.g., image noise for SAR images); and 4) images have rotation, scale, and/or perspective changes.

In certain examples, the satellite images have a lot of visual variations, so the georegistration system is not only concerned with matching images from day to day but from season to season where the landscape (e.g., grasses and trees) has changed. In some examples, the images are taken from different devices, for example, a spectrum camera and another type like infrared. In certain embodiments, the georegistration system can convert images to the same type and/or compare the images of different types.

According to some embodiments, the georegistration system is configured to receive a large image (e.g., 10,000 by 50,000 pixels) and choose selected target points, also referred to as templates (e.g., 60 by 60 pixels). In certain embodiments, georegistration for a large image can be time-consuming (e.g., very time-consuming, 3-5 minutes), while georegistration for selected templates for the image georegistration can be less time-consuming (e.g., 1 minute, 10 seconds). In some embodiments, the georegistration system performs georegistration of the templates, collects desirable matches, computes image transformation and generates a registered image. In certain embodiments, the georegistration system computes an image representation (e.g., one or more feature descriptors) of the templates for georegistration.

In some embodiments, the georegistration system computes the angle weighted oriented gradients (AWOG) representation of the templates for georegistration. In certain embodiments, the georegistration system compares the AWOG representation of the template with reference imagery to determine a match and/or a match score, for example, the template sufficiently matched (e.g., 100%, 80%) the reference imagery. In some embodiments, the georegistration system reiterates the process to find enough matched templates. According to certain embodiments, the georegistration system uses the matched templates to perform georegistration of the image. In some embodiments, the matched templates might be noisy and/or irregular.

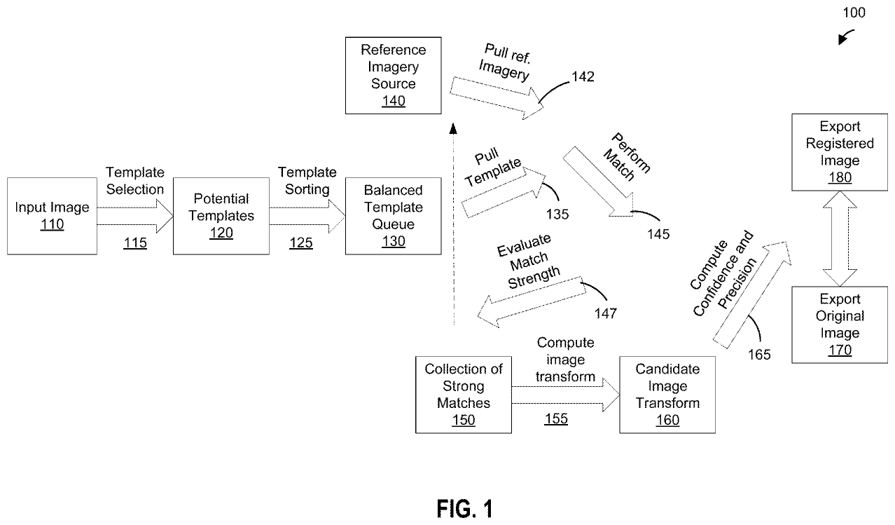

FIG. 1 is a simplified diagram showing a software architecture 100 for a georegistration system according to certain embodiments of the present disclosure. This diagram is merely an example. One of ordinary skill in the art would recognize many variations, alternatives, and modifications. The architecture 100 for the georegistration system includes components and processes 110, 115, 120, 125, 130, 135, 140, 142, 145, 147, 150, 155, 160, 165, 170, and 180. Although the above has been shown using a selected group of components and processes for the software architecture 100 for the georegistration system, there can be many alternatives, modifications, and variations. For example, some of the components and/or processes may be expanded and/or combined. Other components and/or processes may be inserted into those noted above. Depending upon the embodiment, the sequence of processes may be interchanged with others replaced. Further details of these components and processes are found throughout the present disclosure.

According to some embodiments, the georegistration system receives an input image 110 (e.g., still images, live images, image sequences, etc.). In certain embodiments, at the process 115, the georegistration system selects templates (e.g., portions of the image) to determine potential templates 120 (e.g., candidate templates). In some embodiments, at the process 125, the georegistration system performs template sorting to generate a balanced template queue 130.

In some embodiments, the templates selected for matching affect the performance of georegistration. In certain embodiments, too many bad templates attempted slows down the computation. In some embodiments, if templates are concentrated in one area of the image, other areas may not be accurate. In certain embodiments, if template selection is too rigid, the georegistration system may not be able to adapt to challenging or small images due to running out of template candidates. In some embodiments, the georegistration uses a template sorting process (e.g., the process 130) to select templates, for example, to address one or more of the above identified challenges.

According to certain embodiments, the georegistration system generates and/or receives a list of candidate template points, or referred to as candidate points. In some embodiments, each candidate point corresponds to a template and is associated with a pixel location and a score indicating the likelihood of match success. In some examples, the candidate points are Harris Corner points, which are identified corner points in an image. In certain examples, the corner points include a respective numeric score representing the significance of the corner point. In some embodiments, for accurate and efficient georegistration, these points are ordered in a data structure that, when queried, returns one or more points at a time for processing. In certain embodiments, the order in which points are returned is chosen (e.g., carefully chosen) to balance returning points with a respective high score and returning points that are evenly spatially distributed over the image.

According to some embodiments, the image is recursively subdivided into a plurality of cells (e.g., organizing cells), which are arranged into a tree structure (e.g., a binary tree). In certain embodiments, the cells are arranged in a binary tree such that every cell is either a branch cell containing sub-cells (e.g., exactly two sub-cells labeled ‘A’ and ‘B’), or a leaf cell containing no sub-cells. In some embodiments, each cell is set to a state value which is initialized to an initial value (e.g., “blank”). In certain embodiments, a configuration of cells may include might be 2\hat{ }4=16 leaf cells and 2 \hat{4}−1=15 branch cells. In some embodiments, the scored candidate points are distributed into leaf cells based on their spatial locations. In certain embodiments, the candidate points can be ordered in a queue with a cell with the highest scoring point first. In certain embodiments, when the data structure (e.g., the binary tree structure) is queried for a point, it queries the root cell of the structure (e.g., a branch cell) to return the point.

In one example illustrated in FIG. 5, cells A, B, AA, AB, BA, BB are example branch cells, and cells AAA, AAB, ABA, ABB, BAA, BAB, BBA, BBB are example leaf cells. As an example, leaf cell AAA has two candidate points 501 and 502; leaf cell AAB has one candidate point 503, leaf cell BAA includes one candidate point 504, leaf cell BAB includes one candidate point 505, leaf cell ABA includes three candidate points 506, 507, and 508; leaf cell ABB includes the candidate cell 509; leaf cell BBA includes two candidate points 511 and 512. For example, branch cell AA includes two sub-cells AAA and AAB.

According to certain embodiments, the rules for how points are returned from a queried cell are as follows. In some embodiments, if the queried cell is a leaf cell, the georegistration system returns the highest scoring point in the queue of the leaf cell (e.g., leaf cell queue). In certain embodiments, if the queried cell is a branch cell, the georegistration will respond differently depending on the branch cell's state. In some embodiments, if the state of the branch cell is at an initial state (e.g., “blank”), the system checks the sub-cells (e.g., sub-cell A and sub-cell B), returns the highest scoring point from a selected sub-cell (e.g., queried sub-cell) and sets the cell state to the unselected sub-cell (e.g., unqueried sub-cell). For example, if sub-cell A is queried, the state of the branch cell would be set to “B”. As an example, if sub-cell B is queried, the state of the branch cell would be set to “A”. In some embodiments, this ends the behavior for the initial state (e.g., “blank”). In certain embodiments, if the state of the branch cell is set to a label (e.g., either “A” or “B”), the georegistration system queries the corresponding sub-cell and return that point. In some embodiments, since sub-cells A and B correspond to spatial subdivisions (e.g., left side, right side, top side, bottom side, left half, right half, top half, bottom half) of the branch cell, this process ensures that over time a collection of points are returned that is roughly evenly distributed in space.

In the example illustrated in FIG. 5, if the cell BBA is queried and the candidate point 511 has a higher score than the candidate point 512, the candidate point 511 is turned (e.g., added to the template queue). As an example, if the cell AA is queried at its initial state, the scores are 502>501>503, the candidate point 502 is returned and the cell AA is set to state “B”. For example, if the cell AA is queried at state “B”, the candidate point 503 is returned.

According to some embodiments, at the process 135, the georegistration system pulls a template from the balanced template queue 130. In certain embodiments, at the process 142, the georegistration system pulls reference imagery from the reference imagery source 140. In some embodiments, the reference imagery is selected based at least in part on the image characteristics of the input image (e.g., resolutions, types of images, types of sensors used in collecting the images). In some embodiments, at the process 145, the georegistration system performs a match between the template and the reference imagery. In certain embodiments, the georegistration system generates an AWOG representation of the template and performs a matching, also referred to as AWAG matching, between the template and the reference imagery. In certain embodiments, at the process 147, the georegistration system evaluates match strength (e.g., 1 as lowest and 5 as the highest). In some embodiments, the georegistration system repeats the processes 135-147 to identify a collection of templates having strong matches 150. In some embodiments, the georegistration system repeats the processes 135-147 until enough strong matches are found.

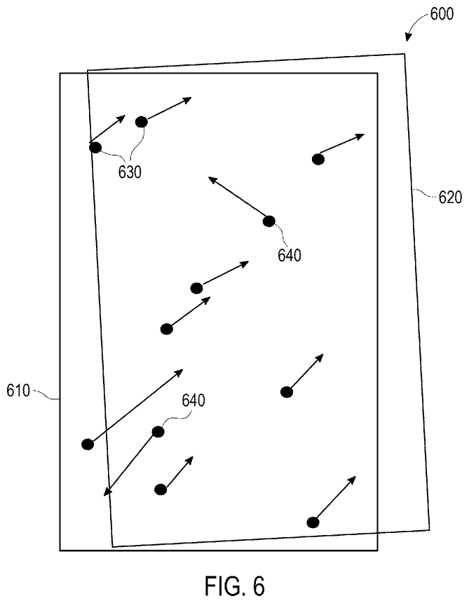

According to certain embodiments, at the process 155, the georegistration system computes image transforms, also referred to as image transformations or transformations, to determine candidate image transform 160 based on the collection of templates having strong matches 150. In some embodiments, each template in the collection of templates having strong matches 150 is associated with a shift (e.g., a preferred shift, a transformation) value and a strength value. FIG. 6 illustrates an example of transform 600 between a template 610 and a reference image 620, each template represented by a point has a shift value, where the shift value is illustrated as a respective arrow. In certain embodiments, there will be some variance in the shift values 630, and some shift values 640 can be wrong (e.g., outliers).

According to some embodiments, the georegistration system computes a transform (e.g., slide+rotate+scale) that will match the largest number of points (e.g., inliers) while ignoring outliers. In certain embodiments, the georegistration system can use random sample consensus (RANSAC) class of methods. In some examples, because of the complex nature of the inlier shifts, the conventional RANSAC methods are erratic. In some embodiments, the georegistration system does not use the conventional “number of points within a distance threshold” metric. In certain embodiments, the georegistration system uses a loss function to compute a smooth error for every point, for example, to minimize the effect of outliers. In some examples, the georegistration system uses the Lorentz distance, calculating using equation (1)

L=log(1+d\hat{ }2/r), (1)

where d is the distance, and r is a scaling parameter (e.g., set to 2 meters).

According to certain embodiments, the georegistration system conducts image transformation computation with iterations. In some embodiments, the georegistration system conducts image transformation computation with iterations for N iterations. In certain embodiments, the georegistration system selects a number of points at random and computes the (affine) transform matching those selected points. In some embodiments, the georegistration system selects a predetermined number of points at random and computes the transform (e.g., affine transform) matching those selected points. In certain embodiments, the georegistration system uses one point for a translation.

According to some embodiments, the georegistration system applies a nonlinear algorithm (e.g., a Levenberg-Marquardt nonlinear algorithm) to determine an error associated with the transform, which is the sum of the distances (e.g., Lorentz distances) between every point's shift value (e.g., preferred shift value). In certain embodiments, a nonlinear algorithm ((e.g., a Levenberg-Marquardt nonlinear algorithm) can be used to optimize the transformation to minimize the error. For example, the random sample chooses the starting values for the transform, then the Levenberg-Marquardt algorithm refines the transform from that starting point and outputs a final error associated with the refined transform. In certain embodiments, each point's shift value is weighted by each point's strength value in determine the error.

According to certain embodiments, if the error is lower than all previous transform, the transform is designated as a candidate transform (e.g., best candidate). In some embodiments, the georegistration system completes the N iterations, and at the end of the iterations, returns the candidate image transform 160 (e.g., “best candidate” transform), also referred to as the candidate image transform 160.

According to some embodiments, at process 165, the georegistration system computes a confidence value and a precision value, and computes the registered image 180, also referred to as the georegistered image. In certain embodiments, the georegistration system can repeat the georegistration process (e.g., 115-165) to refine the registration, for example, a first round of coarse correction and a second round of refined registration. In certain embodiments, the georegistration system exports registered images 180 and exports original input image 170. In some embodiments, after computing the candidate image transform 160, the georegistration system computes the precision value by removing statistical outliers, then computing the weighted average distance between point shift values (e.g., preferred shifts) and shifts given by the candidate image transform 160.

According to certain embodiments, the georegistration system computes a confidence value of a transform (e.g., the candidate image transform 160). In some embodiments, given the template matches, the georegistration system computes the sum of the match strength for all inliers and all points (inlier points or outlier points). In certain embodiments, the confidence value is determined based on inlier points. In certain embodiments, the confidence is computed as the weighted sum of the ratio between the inlier sum and some threshold, and the ratio between the inlier sum and the all points sum, for example, using equation (2) below.

(1−mr_weight)*min(1,inlier_match_strength/acceptance threshold)+mr_weight*(inlier_match_strength/total_match_strength) (2),

where mr_weight is a weight value.

In some embodiments, a transform can have a relatively low confidence value either because it has too few or too weak template matches, or because it fails to fit a sufficient proportion of the template matches.

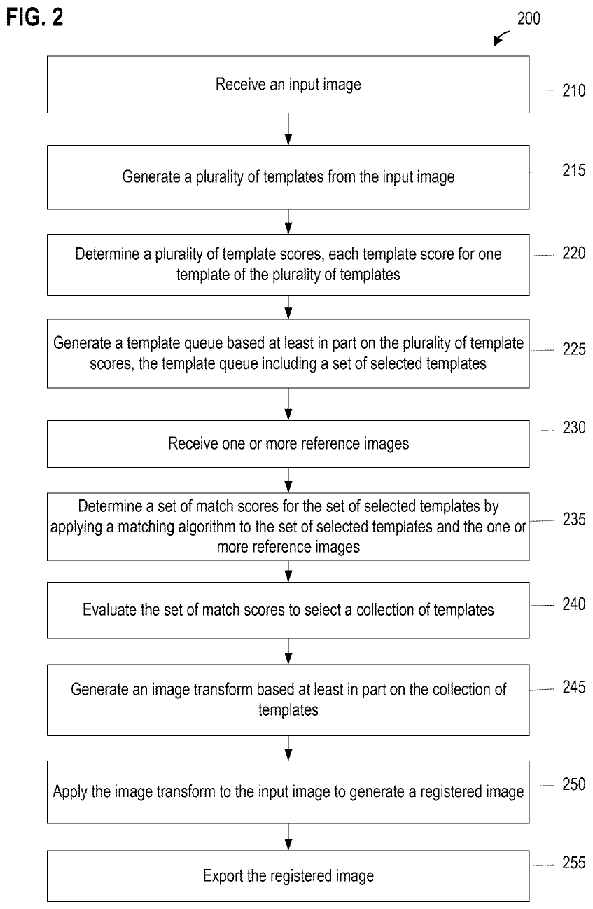

FIG. 2 is a simplified diagram showing a method 200 for georegistration according to certain embodiments of the present disclosure. This diagram is merely an example. One of ordinary skill in the art would recognize many variations, alternatives, and modifications. The method 200 for georegistration includes processes 210, 215, 220, 225, 230, 235, 240, 242, 245, 247, 250, and 255. Although the above has been shown using a selected group of components and processes for the method 200 for georegistration, there can be many alternatives, modifications, and variations. For example, some of the processes may be expanded and/or combined. Other components and/or processes may be inserted into those noted above. Depending upon the embodiment, the sequence of processes may be interchanged with others replaced. Further details of these processes are found throughout the present disclosure.

In some embodiments, some or all processes (e.g., steps) of the method 200 are performed by a system (e.g., the computing system 1100). In certain examples, some or all processes (e.g., steps) of the method 200 are performed by a computer and/or a processor directed by a code. For example, a computer includes a server computer and/or a client computer (e.g., a personal computer). In some examples, some or all processes (e.g., steps) of the method 200 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to some embodiments, at the process 210, the georegistration system receives an input image (e.g., still images, live images, image sequences, etc.). In certain embodiments, at the process 215, the georegistration system generates a plurality of templates from the input image, for example, by dividing the input images into grids as a plurality of cells. In some embodiments, at the process 220, the georegistration system determines a plurality of template scores, each template score for one of the plurality templates.

In some embodiments, the templates selected for matching affect the performance of georegistration. In certain embodiments, too many bad template attempts slow down the computation. In some embodiments, if templates are concentrated in one area of the image, other areas may not be accurate. In certain embodiments, if template selection is too rigid, the georegistration system may not be able to adapt to challenging or small images due to running out of template candidates. In some embodiments, the georegistration uses a template sorting process to select templates, for example, to address one or more of the above identified challenges.

According to certain embodiments, the georegistration system generates and/or receives a list of candidate template points, or referred to as candidate points. In some embodiments, each candidate point is associated with a pixel location and a score indicating the likelihood of match success. In some examples, the candidate points are Harris Corner points, which are identified corner points in an image. In certain examples, the corner points include a respective numeric score representing the significance of the corner point. In some embodiments, for accurate and efficient georegistration, these points are ordered in a data structure that, when queried, returns one or more points at a time for processing. In certain embodiments, the order in which points are returned is chosen (e.g., carefully chosen) to balance returning points with a respective high score and returning points that are evenly spatially distributed over the image.

According to some embodiments, the image is recursively subdivided into a plurality of cells (e.g., organizing cells), which are arranged into a tree structure (e.g., a binary tree). In certain embodiments, the cells are arranged in a binary tree such that every cell is either a branch cell containing sub-cells (e.g., exactly two sub-cells labeled ‘A’ and ‘B’), or a leaf cell containing no sub-cells. In some embodiments, each cell is set to a state value which is initialized to an initial value (e.g., “blank”). In certain embodiments, a configuration of cells may include might be 2\hat{ }4=16 leaf cells and 2 \hat{ }4−1=15 branch cells. In some embodiments, the scored candidate points are distributed into leaf cells based on their spatial locations. In certain embodiments, the candidate points can be ordered in a queue with a cell with the highest scoring point first. In certain embodiments, when the data structure (e.g., the binary tree structure) is queried for a point, it queries the root cell of the structure (e.g., a branch cell) to return the point.

In one example illustrated in FIG. 5, cells A, B, AA, AB, BA, BB are example branch cells, and cells AAA, AAB, ABA, ABB, BAA, BAB, BBA, BBB are example leaf cells. As an example, leaf cell AAA has two candidate points 501 and 502; leaf cell AAB has one candidate point 503, leaf cell BAA includes one candidate point 504, leaf cell BAB includes one candidate point 505, leaf cell ABA includes three candidate points 506, 507, and 508; leaf cell ABB includes the candidate cell 509; leaf cell BBA includes two candidate points 511 and 512. For example, branch cell AA includes two sub-cells AAA and AAB.

According to certain embodiments, the rules for how points are returned from a queried cell are as follows. In some embodiments, if the queried cell is a leaf cell, the georegistration system returns the highest scoring point in the queue of the leaf cell (e.g., leaf cell queue). In certain embodiments, if the queried cell is a branch cell, the georegistration will respond differently depending on the branch cell's state. In some embodiments, if the state of the branch cell is at an initial state (e.g., “blank”), the system checks the sub-cells (e.g., sub-cell A and sub-cell B), returns the highest scoring point from a selected sub-cell (e.g., queried sub-cell) and sets the cell state to the unselected sub-cell (e.g., unqueried sub-cell). For example, if sub-cell A is queried, the state of the branch cell would be set to “B”. As an example, if sub-cell B is queried, the state of the branch cell would be set to “A”. In some embodiments, this ends the behavior for the initial state (e.g., “blank”). In certain embodiments, if the state of the branch cell is set to a label (e.g., either “A” or “B”), the georegistration system queries the corresponding sub-cell and return that point. In some embodiments, since sub-cells A and B correspond to spatial subdivisions (e.g., left side, right side, top side, bottom side, left half, right half, top half, bottom half) of the branch cell, this process ensures that over time a collection of points are returned that is roughly evenly distributed in space.

In the example illustrated in FIG. 5, if the cell BBA is queried and the candidate point 511 has a higher score than the candidate point 512, the candidate point 511 is turned (e.g., added to the template queue). As an example, if the cell AA is queried at its initial state, the scores are 502>501>503, the candidate point 502 is returned and the cell AA is set to state “B”. For example, if the cell AA is queried at state “B”, the candidate point 503 is returned.

According to some embodiments, at the process 225, the georegistration system generates a template queue based at least in part on the plurality of template scores, where the template queue includes a set of selected templates. In certain embodiments, at the process 230, the georegistration system receives one or more reference images, for example, from a reference imagery source. In some embodiments, the reference imagery is selected based at least in part on the image characteristics of the input image (e.g., resolutions, types of images, types of sensors used in collecting the images). In some embodiments, the georegistration system performs a match between the template and the reference imagery. In certain embodiments, the georegistration system performs AWOG matching (e.g., using the AWOG representation for matching) between the template and the reference imagery. In some embodiments, at the process 235, the georegistration system determines a set of match scores for the set of selected templates by applying a matching algorithm to the set of selected templates and at least one reference image of the one or more reference images. In certain embodiments, at the process 240, the georegistration system evaluates the set of match scores to select a collection of templates, for example, based on selection criteria. In some embodiments, the selection criteria include a match score being higher than a predetermined threshold. In some embodiments, the search criteria include a criterion associated with a template distribution in the input image, for example, every quarter of the input image should have at least one associated template.

According to certain embodiments, at the process 245, the georegistration system generates an image transform based at least in part on the collection of templates. In some embodiments, the georegistration system computes multiple image transforms based on multiple sets of points of a template, evaluate the multiple image transforms, and determine the image transform based on the collection of templates. In some embodiments, each template in the collection of templates is associated with a shift (e.g., a preferred shift, a transformation) value and a strength value. FIG. 6 illustrates an example of transform 600 between a template 610 and a reference image 620, each template represented by a point has a shift value, where the shift value is illustrated as a respective arrow. In certain embodiments, there will be some variance in the shift values for templates 630, and some shift values for some templates 640 can be wrong (e.g., outliers).

According to some embodiments, the georegistration system computes a transform (e.g., slide+rotate+scale) that will match the largest number of points (e.g., inliers) while ignoring outliers. In certain embodiments, the georegistration system can use random sample consensus (RANSAC) class of methods. In certain embodiments, the georegistration system uses a loss function to compute a smooth error for every point, for example, to minimize the effect of outliers.

According to certain embodiments, the georegistration system conducts image transformation computation with iterations. In some embodiments, the georegistration system conducts image transformation computation with iterations for N iterations. In certain embodiments, the georegistration system selects a number of points at random and computes the (affine) transform matching those selected points. In some embodiments, the georegistration system selects a predetermined number of points at random and computes the transform (e.g., affine transform) matching those selected points. In certain embodiments, the georegistration system uses one point for a translation.

According to some embodiments, the georegistration system applies a nonlinear algorithm (e.g., a Levenberg-Marquardt nonlinear algorithm) to determine an error associated with the transform, which is the sum of the distances (e.g., Lorentz distances) between every point's shift value (e.g., preferred shift value). In certain embodiments, each point's shift value is weighted by each point's strength value in determine the error.

According to certain embodiments, if the error is lower than all previous transform, the transform is designated as a candidate transform (e.g., best candidate). In some embodiments, the georegistration system completes the N iterations, and at the end of the iterations, returns the candidate transform (e.g., “best candidate” transform), also referred to as the candidate image transform. In certain embodiments, the georegistration system computes a confidence value and a precision value for the candidate transform.

According to some embodiments, at the process 250, the georegistration system applies the image transform to the input image to generate a registered image, also referred to as the georegistered image. In certain embodiments, the georegistration system can repeat the georegistration process (e.g., 215-250) to refine the registration, for example, to generate a coarse correction at the first round and generate a refine registration at the second round. In some embodiments, at the process 255, the georegistration system exports the registered image.

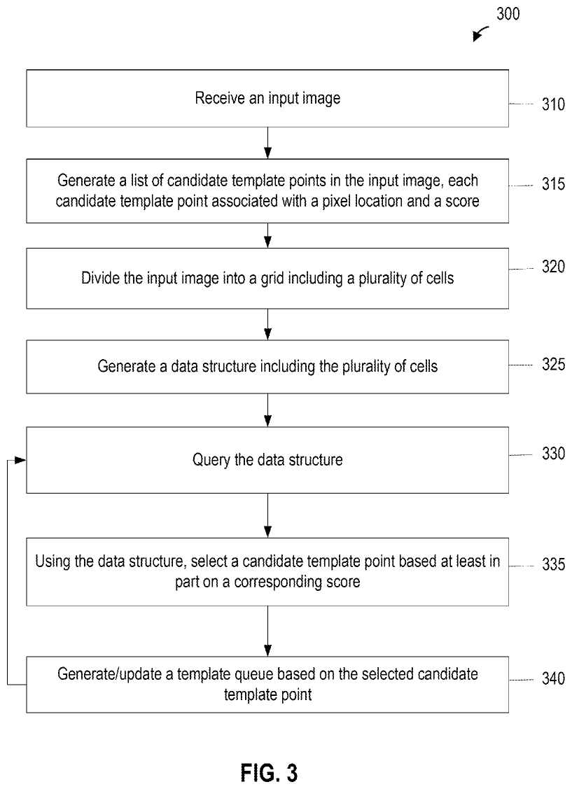

FIG. 3 is a simplified diagram showing a method 300 for sorting templates and/or generating a template queue according to certain embodiments of the present disclosure. This diagram is merely an example. One of ordinary skill in the art would recognize many variations, alternatives, and modifications. The method 300 for sorting templates and/or generating a template queue includes processes 310, 315, 320, 325, 330, 335, and 340. Although the above has been shown using a selected group of processes for the method 300 for sorting templates and/or generating a template queue, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In some embodiments, some or all processes (e.g., steps) of the method 300 are performed by a system (e.g., the computing system 1100). In certain examples, some or all processes (e.g., steps) of the method 300 are performed by a computer and/or a processor directed by a code. For example, a computer includes a server computer and/or a client computer (e.g., a personal computer). In some examples, some or all processes (e.g., steps) of the method 300 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to certain embodiments, at the process 310, the georegistration system receives an input image. In some embodiments, at the process 315, the georegistration system generates or receives a list of candidate template points (e.g., corner points) corresponding to a list of templates. In some embodiments, each candidate template point is associated with a pixel location and a score indicating the likelihood of match success. In some examples, the candidate template points are Harris Corner points, which are identified corner points in an image.

According to some embodiments, at the process 320, the georegistration system divides the input image into a grid including a plurality of cells, where each cell includes one or more candidate template points, or no candidate template point. In certain embodiments, the georegistration system divides the input image recursively in alternating directions until the desired granularity is reached (e.g., a 16×16 grid).

According to some embodiments, at the process 325, the georegistration system generates a data structure (e.g., a tree structure, a binary tree) including the plurality of cells. In certain embodiments, the data structure is a tree structure. In some embodiments, the data structure is a binary tree structure. In certain embodiments, at the process 330, the georegistration system starts to query the data structure, for example, to select a next template to add to a template queue.

According to certain embodiments, at the process 335, the georegistration system selects a candidate template point, using the data structure, based at least in part on a corresponding template score. In some embodiments, each cell of the plurality of cells is set to a state indicating selection criteria associated with the cell. In certain embodiments, a cell is set to an initial state. In some embodiments, the initial state indicates a selection criterion that a highest scoring template point should be selected from one or more candidate template points in the cell queue (e.g., a queue of candidate template points in the cell that are unselected before). In certain embodiments, a cell is set to a designation state indicating that a point (e.g., a highest scoring template point) in a designated cell or sub-cell should be selected. In some embodiments, after a candidate template point is selected, the states of one or more cells associated with the candidate template point are updated to designate a sub-cell for selecting a subsequent template point. In certain embodiments, after a candidate template point is selected, the states of one or more cells associated with the candidate template point are updated, for example, to enable better distribution of selected template points.

According to some embodiments, at the process 340, the georegistration system generates and/or update a template queue based on the selected candidate template point. In certain embodiments, a template queue is generated to include a template corresponding to the selected candidate template point. In some embodiments, a template queue is updated by adding a template corresponding to the selected candidate template point. In certain embodiments, a template queue is updated by adding a template corresponding to the selected candidate template point at the end of the template queue. In some embodiments, the georegistration system ensures that no spatial region is left untouched as more points are selected.

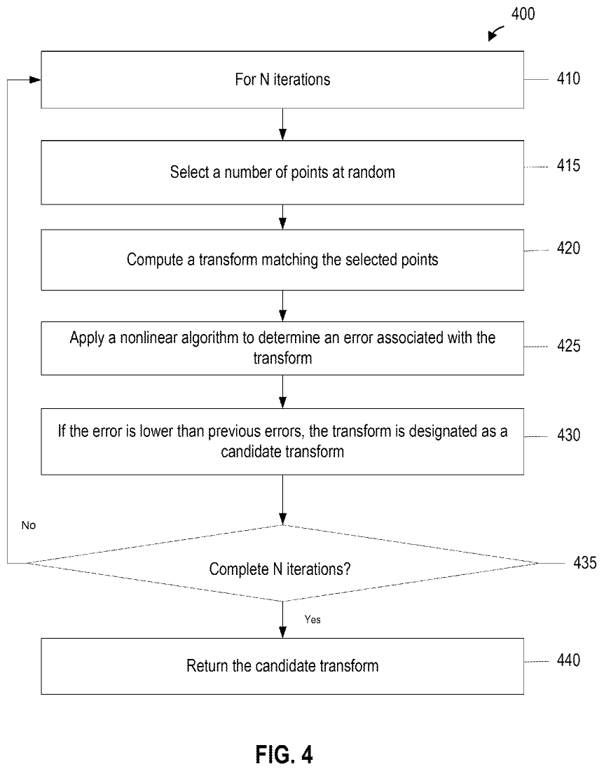

FIG. 4 is a simplified diagram showing a method 400 for generating a transformation (e.g., an image transformation) according to certain embodiments of the present disclosure. This diagram is merely an example. One of ordinary skill in the art would recognize many variations, alternatives, and modifications. The method 400 for generating a transformation (e.g., an image transformation) includes processes 410, 415, 420, 425, 430, 435, and 440. Although the above has been shown using a selected group of processes for the method 400 for generating a transformation (e.g., an image transformation), there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In some embodiments, some or all processes (e.g., steps) of the method 400 are performed by a system (e.g., the computing system 1100). In certain examples, some or all processes (e.g., steps) of the method 400 are performed by a computer and/or a processor directed by a code. For example, a computer includes a server computer and/or a client computer (e.g., a personal computer). In some examples, some or all processes (e.g., steps) of the method 400 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to certain embodiments, at the process 410, the georegistration system conducts image transformation computation for N iterations. In some embodiments, the georegistration system conducts image transformation computation with iterations. In certain embodiments, at the process 415, the georegistration system selects a number of points (e.g., 3 points) at random, at the process 420, the georegistration system computes a transform matching the selected points. In some embodiments, the georegistration system selects a predetermined number of points at random and computes the transform (e.g., affine transform) matching those selected points. In certain embodiments, the georegistration system selects one point for a translation.

According to some embodiments, at the process 425, the georegistration system applies a nonlinear algorithm (e.g., a Levenberg-Marquardt nonlinear algorithm) to determine an error associated with the transform. In certain embodiments, the georegistration system applies the nonlinear algorithm to the sum of the distances (e.g., Lorentz distances) between every point's shift value (e.g., preferred shift value). In certain embodiments, each point's shift value is weighted by each point's strength value in determining the error.

According to certain embodiments, at the process 430, if the error is lower than all previous transform, the transform is designated as a candidate transform (e.g., best candidate). In some embodiments, at the process 435, the georegistration system determines whether the N iterations have been completed. In certain embodiments, the georegistration system goes back to the process 410 if the N iterations have not been completed. In some embodiments, the georegistration system goes to the process 440 if the N iterations have been completed. In certain embodiments, at the process 440, the georegistration system returns the candidate transform (e.g., the best candidate transform).

FIG. 7 is an illustrative example of a georegistration environment 700, according to certain embodiments of the present disclosure. FIG. 7 is merely an example. One of the ordinary skilled in the art would recognize many variations, alternatives, and modifications. According to certain embodiments, the georegistration environment 700 includes a georegistration system 710 and one or more imaging systems 740 (e.g., imaging system 740A, imaging system 740B, . . . , imaging system 740N). According to some embodiments, the georegistration system 710 includes one or more processors 720 for image georegistration and one or more memories 730, also refers to as a repository 730. In certain embodiments, the repository 730 includes one or more reference imagery sources 732 for storing data (e.g., reference images). In some embodiments, the repository 730 can be accessed by the one or more imaging systems 740. Although the above has been shown using a selected group of components in the georegistration environment 700, there can be many alternatives, modifications, and variations. For example, some of the components may be expanded and/or combined. Other components may be inserted into those noted above. Depending upon the embodiment, the arrangement of components may be interchanged with others replaced. Further details of these components are found throughout the present disclosure.

According to some embodiments, the georegistration system 710 receives an input image (e.g., still images, live images, image sequences, etc.). In certain embodiments, the georegistration system 710 generates a plurality of templates from the input image, for example, by dividing the input images into grids as a plurality of cells. In some embodiments, the georegistration system 710 determines a plurality of template scores, each template score for one of the plurality templates.

In some embodiments, the templates selected for matching affect the performance of georegistration. In certain embodiments, too many bad template attempts slow down the computation. In some embodiments, if templates are concentrated in one area of the image, other areas may not be accurate. In certain embodiments, if template selection is too rigid, the georegistration system 710 may not be able to adapt to challenging or small images due to running out of template candidates. In some embodiments, the georegistration uses a template sorting process to select templates, for example, to address one or more of the above identified challenges.

According to certain embodiments, the georegistration system 710 generates or receives a list of candidate template points, or referred to as candidate points. In some embodiments, each candidate point is associated with a pixel location and a score indicating the likelihood of match success. In some examples, the candidate points are Harris Corner points, which are identified corner points in an image. In certain embodiments, the georegistration system 710 subdivides the input image recursively in alternating directions until the desired granularity is reached (e.g., a 16×16 grid). In some embodiments, the georegistration system 710 divides the input image into a grid including a plurality of templates (e.g., cells).

According to some embodiments, the georegistration system 710 groups the candidate points by which cell (e.g., leaf cell) they fall into and sort each cell's list of points in order of descending score. In some examples, a cell can be divided into sub-cells and a score can be determined based on the candidate points in the sub-cells. According to certain embodiments, the georegistration system 710 identifies one or more cells as the templates that are returning high scoring points (e.g., highest scoring points). In some embodiments, the georegistration system 710 ensures that no spatial region is left untouched as more points are selected.

According to some embodiments, the georegistration system 710 generates a template queue based at least in part on the plurality of template scores, where the template queue includes a set of selected templates. In certain embodiments, the georegistration system 710 receives one or more reference images, for example, from a reference imagery source. In some embodiments, the georegistration system 710 performs a match between the template and the reference imagery. In certain embodiments, the georegistration system 710 performs AWOG matching (e.g., using the AWOG representation for matching) between the template and the reference imagery. In some embodiments, the georegistration system 710 determines a set of match scores for the set of selected templates by applying a matching algorithm to the set of selected templates and at least one reference image of the one or more reference images. In certain embodiments, the georegistration system 710 evaluates the set of match scores to select a collection of templates, for example, based on selection criteria. In some embodiments, the selection criteria include a match score being higher than a predetermined threshold. In some embodiments, the search criteria include a criterion associated with a template distribution in the input image, for example, every quarter of the input image should have at least one associated template.

According to certain embodiments, the georegistration system 710 generates an image transform based at least in part on the collection of templates. In some embodiments, the georegistration system 710 computes multiple image transforms based on multiple sets of points of a template, evaluate the multiple image transforms, and determine the image transform based on the collection of templates. In some embodiments, each template in the collection of templates is associated with a shift (e.g., a preferred shift, a transformation) value and a strength value. FIG. 6 illustrates an example of transform 600 between a template 610 and a reference image 620, each template represented by a point has a shift value, where the shift value is illustrated as a respective arrow. In certain embodiments, there will be some variance in the shift values for templates 630, and some shift values for some templates 640 can be wrong (e.g., outliers).

According to some embodiments, the georegistration system 710 computes a transform (e.g., slide+rotate+scale) that will match the largest number of points (e.g., inliers) while ignoring outliers. In certain embodiments, the georegistration system 710 can use random sample consensus (RANSAC) class of methods. In certain embodiments, the georegistration system 710 uses a loss function to compute a smooth error for every point, for example, to minimize the effect of outliers.

According to certain embodiments, the georegistration system 710 conducts image transformation computation with iterations. In some embodiments, the georegistration system 710 conducts image transformation computation with iterations for N iterations. In certain embodiments, the georegistration system 710 selects a number of points at random and computes the (affine) transform matching those selected points. In some embodiments, the georegistration system 710 selects a predetermined number of points at random and computes the transform (e.g., affine transform) matching those selected points. In certain embodiments, the georegistration system 710 uses one point for a translation.

According to some embodiments, the georegistration system 710 applies a nonlinear algorithm (e.g., a Levenberg-Marquardt nonlinear algorithm) to determine an error associated with the transform, which is the sum of the distances (e.g., Lorentz distances) between every point's shift value (e.g., preferred shift value). In certain embodiments, each point's shift value is weighted by each point's strength value in determine the error.

According to certain embodiments, if the error is lower than all previous transform, the transform is designated as a candidate transform (e.g., best candidate). In some embodiments, the georegistration system 710 completes the N iterations, and at the end of the iterations, returns the candidate transform (e.g., “best candidate” transform), also referred to as the candidate image transform. In certain embodiments, the georegistration system 710 computes a confidence value and a precision value for the candidate transform.

According to some embodiments, the georegistration system 710 applies the image transform to the input image to generate a registered image, also referred to as the georegistered image. In certain embodiments, the georegistration system 710 can repeat the georegistration process to refine the registration, for example, to generate a coarse correction in the first round and generate a refine registration in the second round. In some embodiments, the georegistration system 710 exports the registered image. FIG. 9A is an example input image 900A, FIG. 9B is an example reference image 900B, and FIG. 9C is an example registered image 900C generated based on the example input image 900A and the example reference image 900B.

In some embodiments, the repository 730 can include software instructions, input images, reference images, registered images, templates in images, scores associated with templates, image transforms, transformations, template queues, and/or the like. The repository 730 may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components in the georegistration environment 700 can execute software or firmware stored in non-transitory computer-readable medium to implement various processing steps. Various components and processors of the i georegistration environment 700 can be implemented by one or more computing devices including, but not limited to, circuits, a computer, a cloud-based processing unit, a processor, a processing unit, a microprocessor, a mobile computing device, and/or a tablet computer. In some cases, various components of the georegistration environment 700 (e.g., the georegistration system 710, the imaging systems 740) can be implemented on a shared computing device. Alternatively, a component of the georegistration environment 700 can be implemented on multiple computing devices. In some implementations, various modules and components of the georegistration environment 700 can be implemented as software, hardware, firmware, or a combination thereof. In some cases, various components of the georegistration environment 700 can be implemented in software or firmware executed by a computing device.

Various components of the georegistration environment 700 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

Georegistration for Full Motion Video

According to some embodiments, video georegistration is accomplished by a collection of individual components of a georegistration system. In certain embodiments, each of these is an individual AIP (artificial intelligence (AI) inference platform) (e.g., a model orchestrator) processor (e.g., a computing unit implementing AIP), running in parallel behind the aggregation filter processor (e.g., a computing unit implementing AIP). In some embodiments, a processor refers to a computing unit implementing a model (e.g., a computational model, an algorithm, an AI model, etc.).

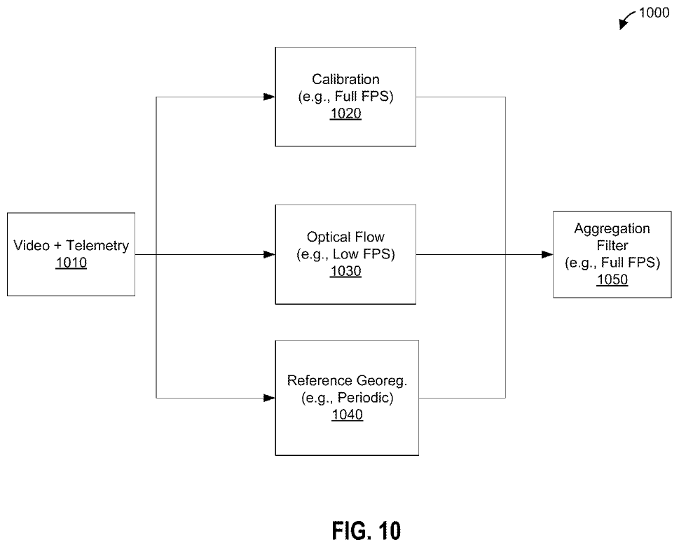

FIG. 10 is an illustrative diagram for a video georegistration system 1000. FIG. 10 is merely an example. One of the ordinary skilled in the art would recognize many variations, alternatives, and modifications. For example, some of the components may be expanded, integrated, and/or combined. Other components may be inserted into those noted above. Depending upon the embodiment, the arrangement of components may be interchanged with others replaced. Further details of these components are found throughout the present disclosure.

According to certain embodiments, as shown in FIG. 10, the georegistration system 1000 includes a video and telemetry component 1010, a calibration processor 1020, an optical-flow processor 1020, a reference georegistration processor 1040, and/or an aggregation filter processor 1050. In some embodiments, the georegistration system 1000 receives feedback or performs multiple stages of filtering so that, for instance, the best pre-reference-georegistration estimate can be used to seed the reference georegistration. In certain embodiments, the different components are expected to run at different FPS (frames-per-second) values, based on their computational demands. In some embodiments, the aggregation filter can integrate the various feeds into an estimate (e.g., a wholistic estimate). In some embodiments, the video and telemetry component 1010 receives videos with geo-coordinates information. In certain embodiments, the video and telemetry component 1010 can extract geo-coordinates information from videos (e.g., videos with telemetry overlay).

According to certain embodiments, the aggregation filter 1050 can use full FPS. In some embodiments, this processor implements a Kalman filter-style algorithm to synthesize estimates of the geocoordinates (e.g., true geocoordinates) based on the various observations provided by the other processors. In certain embodiments, the georegistration system 1000 is adapt to the variable availability of the different streams, including dropouts or missing processors, continuing to provide the estimate (e.g., best available estimate) and predicted confidence. According to certain embodiments, the georegistration system 1000 and/or the calibration processor 1020 can perform calibration to video frames at a selected FPS. In some embodiments, the calibration processor 1020 can perform calibration to video frames at full FPS, for example, each video frame is calibrated. In some embodiments, the aggregation filter 1050 requires lightweight computational cost (e.g., a few milliseconds, a couple of milliseconds). In certain embodiments, the georegistration system 1000 can perform calibration on available FPS. In some embodiments, the calibration processor 1020 uses historical telemetry data (e.g., past telemetry) and/or any corrections (e.g., baked-in corrections). In certain embodiments, the calibration processor 1020 requires lightweight computational cost (e.g., a few milliseconds, a couple of milliseconds).

According to some embodiments, the optical-flow processors 1030 uses low FPS (e.g., 5 FPS, adaptive FPS). In certain embodiments, the georegistration system 1000 computes an optical-flow-based motion model to provide an alternative, smoothed estimate of the motion of the starebox. In some embodiments, depending on performance profiles, the georegistration system 1000 moves the computational kernel for the optical-flow processor into a specific library (e.g., a C++ library). In certain embodiments, DTM (data transfer mechanism) or similar data is needed to translate visual motion to estimated physical motion. In some embodiments, the optical-flow processor 1030 requires middleweight computational cost (e.g., tens of milliseconds or more). In certain embodiments, the optical-flow processor 1030 extracts relative motions of objects from video frames to make corrections.

According to certain embodiments, the reference georegistration processor 1040 does reference georegistration periodically (e.g., 1 FPS or less). In some embodiments, the reference georegistration processor 1040 registers the video frame or some derived composite against reference imagery. In certain embodiments, the georegistration system 1000 may use the video frame itself or use compositing multiple frames to get more data.

In some embodiments, the georegistration system 1000 may compare against overhead reference imagery or pre-project the reference or input imagery based on the predicted look angle. In certain embodiments, the georegistration system 1000 may use various algorithms (e.g., class of algorithm) including, for example, algorithms to support multimodal (e.g., EO and IR) results. In some embodiments, depending on performance profiles, the georegistration system 1000 moves the computational kernel for the reference georegistration processor 1040 into a specific library (e.g., a C++ library).

In some embodiments, the reference georegistration processor 1040 requires heavyweight computational cost (e.g., less than 1 second). In certain embodiments, the calibration processor 1020 processes video frames at a first frame rate (e.g., once every frame, once every other frame, once every J frames). In some embodiments, the optical flow processor 1030 processes video frames at a second frame rate (e.g., once every M frames). In certain embodiments, the reference georegistration processor 1040 processes video frames at a third frame rate (e.g., once every N frames). In some embodiments, the first frame rate is higher than the second frame rate. In certain embodiments, the second frame rate is higher than the third frame rate. In some embodiments, J<M<N, for the frame rates.

According to certain embodiments, the reference georegistration processor 1040 processes video frames for reference georegistration at a dynamic frame rate. In some embodiments, the reference georegistration processor 1040 performs georegistration at a first frame rate at a first time. In certain embodiments, the reference georegistration processor 1040 performs georegistration at a second frame rate at a second time, where the first frame rate is different from the second frame rate. In some embodiments, the reference georegistration processor 1040 is configured to perform georegistration when there are available processing resources (e.g., computing processing unit (CPU), graphics processing unit (GPU)).

In certain embodiments, the georegistration system 1000 includes a projection processor for projection. In some embodiments, the georegistration system projects against a DEM (digital elevation model). In certain embodiments, the projection processor is a standalone processor. In some embodiments, the projection processor is a part of the reference georegistration processor 1040 or a part of the aggregation filter processor 1050.

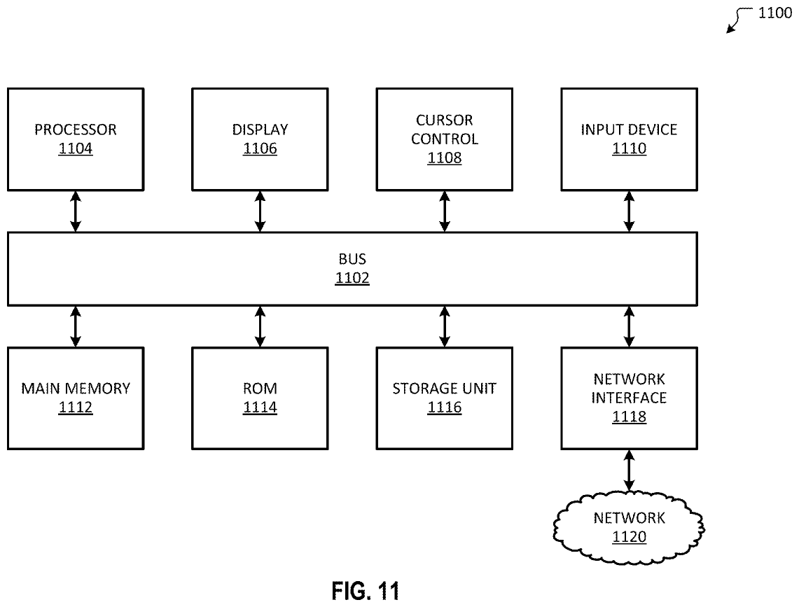

FIG. 11 is a simplified diagram showing a computing system for implementing a system 1100 for georegistration in accordance with at least one example set forth in the disclosure. This diagram is merely an example, which should not unduly limit the scope of the claims. One of ordinary skill in the art would recognize many variations, alternatives, and modifications.

The computing system 1100 includes a bus 1102 or other communication mechanism for communicating information, a processor 1104, a display 1106, a cursor control component 1108, an input device 1110, a main memory 1112, a read only memory (ROM) 1114, a storage unit 1116, and a network interface 1118. In some embodiments, some or all processes (e.g., steps) of the methods 200, 300, and/or 400 are performed by the computing system 1100. In some examples, the bus 1102 is coupled to the processor 1104, the display 1106, the cursor control component 1108, the input device 1110, the main memory 1112, the read only memory (ROM) 1114, the storage unit 1116, and/or the network interface 1118. In certain examples, the network interface is coupled to a network 1120. For example, the processor 1104 includes one or more general purpose microprocessors. In some examples, the main memory 1112 (e.g., random access memory (RAM), cache and/or other dynamic storage devices) is configured to store information and instructions to be executed by the processor 1104. In certain examples, the main memory 1112 is configured to store temporary variables or other intermediate information during execution of instructions to be executed by processor 1104. For examples, the instructions, when stored in the storage unit 1116 accessible to processor 1104, render the computing system 1100 into a special-purpose machine that is customized to perform the operations specified in the instructions. In some examples, the ROM 1114 is configured to store static information and instructions for the processor 1104. In certain examples, the storage unit 1116 (e.g., a magnetic disk, optical disk, or flash drive) is configured to store information and instructions.

In some embodiments, the display 1106 (e.g., a cathode ray tube (CRT), an LCD display, or a touch screen) is configured to display information to a user of the computing system 1100. In some examples, the input device 1110 (e.g., alphanumeric and other keys) is configured to communicate information and commands to the processor 1104. For example, the cursor control component 1108 (e.g., a mouse, a trackball, or cursor direction keys) is configured to communicate additional information and commands (e.g., to control cursor movements on the display 1106) to the processor 1104.

According to certain embodiments, a method for image georegistration is provided. The method comprises: receiving an input image; generating a plurality of templates from the input image, the plurality of templates being associated with a plurality of template scores; generating a template queue based at least in part on the plurality of template scores, the template queue including a set of selected templates; receiving one or more reference images; determining a set of match scores for the set of selected templates by applying a matching algorithm to the set of selected templates and at least one reference image of the one or more reference images; evaluating the set of match scores to select a collection of templates, each template of the collection of templates meeting one or more selection criteria; and generating an image transform based at least in part on the collection of templates; wherein the method is performed using one or more processors. For example, the method is implemented according to at least FIG. 1, FIG. 2, FIG. 3, and/or FIG. 4.

In some embodiments, each template of the plurality of templates is associated with a pixel location in the input image. In certain embodiments, the generating a template queue based at least in part on the plurality of template scores comprises: generating the template queue based at least in part on the plurality of template scores and a plurality of pixel locations associated with the plurality of templates. In some embodiments, the generating a template queue based at least in part on the plurality of template scores comprises: generating a data structure including a plurality of template points corresponding to the plurality of pixel locations of the plurality of templates; and selecting the set of selected templates using the data structure. In certain embodiments, the generating an image transform comprises: selecting a first set of points from a first template in the collection of templates; computing a first transform based at least in part on the first set of selected points and the at least one reference image; applying a nonlinear algorithm to determine a first error associated with the first transform; setting the image transform as the first transform; selecting a second set of points from the first template; computing a second transform based at least in part on the second set of selected points and the at least one reference image; applying a nonlinear algorithm to determine a second error associated with the first transform; and if the second error is lower than the first error, setting the image transform as the second transform.

In certain embodiments, the method further includes the steps of determining a subset of inlier templates in the collection of templates; and determining a confidence value of the image transformation based at least in part on the subset of inlier templates and the collection of templates. In some embodiments, the applying a matching algorithm includes: generating an angle weighted oriented gradients (AWOG) representation of a first template of the plurality of templates; and determining one match score of the set of match scores based at least in part on the AWOG representation of the first template and the at least one reference image. In certain embodiments, the selection criteria include a match scoring being higher than a predetermined threshold. In some embodiments, the selection criteria include a criterion associated with a template distribution in the input image. In certain embodiments, the method further includes the steps of: applying the image transform to the input image to generate a registered image; and exporting the registered image. In some embodiments, the input image is an image taken from a satellite.

According to some embodiments, a system for image georegistration is provided. The system comprises: one or more memories having instructions stored thereon; and one or more processors configured to execute the instructions and perform operations comprise: receiving an input image; generating a plurality of templates from the input image, the plurality of templates being associated with a plurality of template scores; generating a template queue based at least in part on the plurality of template scores, the template queue including a set of selected templates; receiving one or more reference images; determining a set of match scores for the set of selected templates by applying a matching algorithm to the set of selected templates and at least one reference image of the one or more reference images; evaluating the set of match scores to select a collection of templates, each template of the collection of templates meeting one or more selection criteria; and generating an image transform based at least in part on the collection of templates. For example, the system is implemented according to at least FIG. 1, FIG. 2, FIG. 3, FIG. 4, and/or FIG. 7.

In some embodiments, each template of the plurality of templates is associated with a pixel location in the input image. In certain embodiments, the generating a template queue based at least in part on the plurality of template scores comprises: generating the template queue based at least in part on the plurality of template scores and a plurality of pixel locations associated with the plurality of templates. In some embodiments, the generating a template queue based at least in part on the plurality of template scores comprises: generating a data structure including a plurality of template points corresponding to the plurality of pixel locations of the plurality of templates; and selecting the set of selected templates using the data structure. In certain embodiments, the generating an image transform comprises: selecting a first set of points from a first template in the collection of templates; computing a first transform based at least in part on the first set of selected points and the at least one reference image; applying a nonlinear algorithm to determine a first error associated with the first transform; setting the image transform as the first transform; selecting a second set of points from the first template; computing a second transform based at least in part on the second set of selected points and the at least one reference image; applying a nonlinear algorithm to determine a second error associated with the first transform; and if the second error is lower than the first error, setting the image transform as the second transform.

In certain embodiments, the operations further include the steps of determining a subset of inlier templates in the collection of templates; and determining a confidence value of the image transformation based at least in part on the subset of inlier templates and the collection of templates. In some embodiments, the applying a matching algorithm includes: generating an angle weighted oriented gradients (AWOG) representation of a first template of the plurality of templates; and determining one match score of the set of match scores based at least in part on the AWOG representation of the first template and the at least one reference image. In certain embodiments, the selection criteria include a match scoring being higher than a predetermined threshold. In some embodiments, the selection criteria include a criterion associated with a template distribution in the input image. In certain embodiments, the operations further include the steps of: applying the image transform to the input image to generate a registered image; and exporting the registered image. In some embodiments, the input image is an image taken from a satellite.

According to certain embodiments, a method for image georegistration is provided. The method comprises: receiving an input image; generating a plurality of templates from the input image, the plurality of templates being associated with a plurality of template scores, and each template of the plurality of templates being associated with a pixel location in the input image; generating a template queue based at least in part on the plurality of template scores and a plurality of pixel locations associated with the plurality of templates, the template queue including a set of selected templates, and the template queue being based at least in part on the plurality of template scores; receiving one or more reference images; determining a set of match scores for the set of selected templates by applying a matching algorithm to the set of selected templates and at least one reference image of the one or more reference images; evaluating the set of match scores to select a collection of templates, each template of the collection of templates meeting one or more selection criteria; and generating an image transform based at least in part on the collection of templates; wherein the method is performed using one or more processors. For example, the method is implemented according to at least FIG. 1, FIG. 2, FIG. 3, and/or FIG. 4.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for image georegistration, the method comprising:
receiving an input image;
generating a plurality of templates from the input image, the plurality of templates being associated with a plurality of template scores;
generating a template queue based at least in part on the plurality of template scores, the template queue including a set of selected templates;
receiving one or more reference images;
determining a set of match scores for the set of selected templates by applying a matching algorithm to the set of selected templates and at least one reference image of the one or more reference images;
evaluating the set of match scores to select a collection of templates, each template of the collection of templates meeting one or more selection criteria; and
generating an image transform based at least in part on the collection of templates;
wherein the method is performed using one or more processors.

2. The method of claim 1, wherein each template of the plurality of templates is associated with a pixel location in the input image, wherein the generating a template queue based at least in part on the plurality of template scores comprises:
generating the template queue based at least in part on the plurality of template scores and a plurality of pixel locations associated with the plurality of templates.

3. The method of claim 2, wherein the generating a template queue based at least in part on the plurality of template scores comprises:
generating a data structure including a plurality of template points corresponding to the plurality of pixel locations of the plurality of templates; and
selecting the set of selected templates using the data structure.

4. The method of claim 1, wherein the generating an image transform comprises:
selecting a first set of points from a first template in the collection of templates;
computing a first transform based at least in part on the first set of selected points and the at least one reference image;
applying a nonlinear algorithm to determine a first error associated with the first transform;
setting the image transform as the first transform;
selecting a second set of points from the first template;
computing a second transform based at least in part on the second set of selected points and the at least one reference image;
applying a nonlinear algorithm to determine a second error associated with the first transform; and
if the second error is lower than the first error, setting the image transform as the second transform.

5. The method of claim 1, further comprising:
determining a subset of inlier templates in the collection of templates; and
determining a confidence value of the image transformation based at least in part on the subset of inlier templates and the collection of templates.

6. The method of claim 1, wherein the applying a matching algorithm includes:
generating an angle weighted oriented gradients (AWOG) representation of a first template of the plurality of templates; and
determining one match score of the set of match scores based at least in part on the AWOG representation of the first template and the at least one reference image.

7. The method of claim 1, wherein the selection criteria include a match score being higher than a predetermined threshold.

8. The method of claim 1, wherein the selection criteria include a criterion associated with a template distribution in the input image.

9. The method of claim 1, further comprising:
applying the image transform to the input image to generate a registered image; and
exporting the registered image.

10. The method of claim 1, wherein the input image is an image taken from a satellite.

11. A system for image georegistration, the system comprising:
one or more memories having instructions stored thereon; and
one or more processors configured to execute the instructions and perform operations comprise:
receiving an input image;
generating a plurality of templates from the input image, the plurality of templates being associated with a plurality of template scores;
generating a template queue based at least in part on the plurality of template scores, the template queue including a set of selected templates;
receiving one or more reference images;
determining a set of match scores for the set of selected templates by applying a matching algorithm to the set of selected templates and at least one reference image of the one or more reference images;
evaluating the set of match scores to select a collection of templates, each template of the collection of templates meeting one or more selection criteria; and
generating an image transform based at least in part on the collection of templates.

12. The system of claim 11, wherein each template of the plurality of templates is associated with a pixel location in the input image, wherein the generating a template queue based at least in part on the plurality of template scores comprises:
generating the template queue based at least in part on the plurality of template scores and a plurality of pixel locations associated with the plurality of templates.

13. The system of claim 12, wherein the generating a template queue based at least in part on the plurality of template scores comprises:
generating a data structure including a plurality of template points corresponding to the plurality of pixel locations of the plurality of templates; and
selecting the set of selected templates using the data structure.

14. The system of claim 11, wherein the generating an image transform comprises:
selecting a first set of points from a first template in the collection of templates;
computing a first transform based at least in part on the first set of selected points and the at least one reference image;
applying a nonlinear algorithm to determine a first error associated with the first transform;
setting the image transform as the first transform;
selecting a second set of points from the first template;
computing a second transform based at least in part on the second set of selected points and the at least one reference image;
applying a nonlinear algorithm to determine a second error associated with the first transform; and
if the second error is lower than the first error, setting the image transform as the second transform.

15. The system of claim 11, wherein the operations further comprise:
determining a subset of inlier templates in the collection of templates; and
determining a confidence value of the image transformation based at least in part on the subset of inlier templates and the collection of templates.

16. The system of claim 11, wherein the applying a matching algorithm includes:
generating an angle weighted oriented gradients (AWOG) representation of a first template of the plurality of templates; and
determining one match score of the set of match scores based at least in part on the AWOG representation of the first template and the at least one reference image.

17. The system of claim 11, wherein the selection criteria include a match score being higher than a predetermined threshold.

18. The system of claim 11, wherein the selection criteria include a criterion associated with a template distribution in the input image.

19. The system of claim 11, wherein the operations further comprise:
applying the image transform to the input image to generate a registered image; and
exporting the registered image.

20. A method for image georegistration, the method comprising:
receiving an input image;
generating a plurality of templates from the input image, the plurality of templates being associated with a plurality of template scores, and each template of the plurality of templates being associated with a pixel location in the input image;
generating a template queue based at least in part on the plurality of template scores and a plurality of pixel locations associated with the plurality of templates, the template queue including a set of selected templates, and the template queue being based at least in part on the plurality of template scores;
receiving one or more reference images;
determining a set of match scores for the set of selected templates by applying a matching algorithm to the set of selected templates and at least one reference image of the one or more reference images;
evaluating the set of match scores to select a collection of templates, each template of the collection of templates meeting one or more selection criteria; and
generating an image transform based at least in part on the collection of templates;
wherein the method is performed using one or more processors.
